(19) United States
(12) Patent Application Publication
(10) Pub. No.: US 2023/0010326 A1
(43) Pub. Date: Jan. 12, 2023

(54) Fall Impact Protection System

(71) Applicant: Brent Davis, Gilbert, AZ (US)

(72) Inventor: Brent Davis, Gilbert, AZ (US)

(21) Appl. No.: 17/368,797

(22) Filed: Jul. 6, 2021

(51) Int. Cl. E04G 21/32

(52) U.S. Cl. CPC E04G 21/3271

(57) ABSTRACT

A grounded and modular fall-impact protection airbag system designed to absorb the kinetic energy of objects or persons falling from high elevations in such a manner that concurrently cushions impact while minimizing the transfer of elastic potential energy that can result in a rebound event. In this manner, the potential for damage or injury is minimized in both the impact and rebound kinetic energy transfer events. In contrast to existing grounded fall-protection airbag systems that require continuous airflow from pneumatic devices to maintain optimal pressure before and after impact, this system provides the to use air pressure release valves that are actuated upon impact and release air pressure at a rate that safely decelerates the object or individual without a rebound effect. This allows for the system to be pressurized once per use, thus decreasing energy requirements and operational costs, improving system reliability, and increasing overall safety to the site.

This application claims the benefit of U.S. Provisional Application No. 63/047,961.

### BACKGROUND SECTION

### Field of the Invention

The invention relates to fall-impact protection systems for industries that require workers to operate with uninhibited mobility from great heights. The present invention is related to a modular and interconnectable welded vinyl airbag system for creating a fall-protection zone. It has a cap and valve system that permits air inflation while precluding depressurization. The system will also provide the option for inserting pressure relief valves that permit the system to depressurize the particular airbag module receiving impact at a rate that safely decelerates the person or object.

### Description of the Related Art

The United States Department of Labor's Occupational Safety and Health Administration (OSHA), reported that in fiscal year 2018 fatal falls, slips, and trips accounted for 33% of fatal injuries in the construction industry and 16% of fatal events in all occupations combined. In the same year, fall protection violations constituted the largest category of cited OSHA standard violations. OSHA regulations require fall protection in industrial and maintenance settings when workers are exposed to fall hazards of 48 inches or higher. (29 CFR 1926.501, 29 CFR 1926.451, 29 CFR 1926.503). While such heights may appear to be inconsequential, significant injuries and deaths occur from such a height every year.

Certain positioning, suspension, and retrieval systems are available in the art. Positioning systems hold workers in place while leaving their hands free to allow work. They are activated every time the workers lean back. There is no fall arrest. Suspension systems lower and support workers while leaving hands free for activities to perform. Retrieval systems are used for rescue after a fall has occurred, which may not have a primary purpose in preventing the initial injury, but in the prevention of further harm or first steps in aiding the potentially injured.

Another category is fall arrest, which is primarily made from nets an lifelines. The fall arrest system comes into services when or if a fall occurs. Retractable lifelines, full body harnesses with shock absorbing lanyards are accepted as personal fall arrest systems. These systems may distribute forces throughout a worker's body, while shock-absorbing lanyards decrease total fall arresting forces. Body belts, chest harnesses, body harnesses, suspension belts, rope lanyards, web lanyards, cable lanyards, rope grabs, retractable lifelines, and safety nets are used in the industry. Shock absorbers reduce fall arresting forces and fall injury risks.

Aircraft fuselage and wing inspection and maintenance can be hazardous without proper safety equipment. OSHA, ANSI, and other organization-compliant fall equipment may use arrest anchors and horizontal lifelines to make the work environment on top and inside aircraft, inside and outside the hangar, safe and productive.

In light of the regulatory requirements, risks, and liabilities associated with falls, all industrial employers are highly invested in establishing effective fall protection systems that meet and exceed regulatory requirements in a cost-effective manner while maximizing employee mobility and productivity. Fall protection is of particular importance in the construction, aviation, manufacturing, and entertainment industries (e.g., stunt fall protection) but is also seeing rapid adoption in the sports and recreation industries (e.g, gymnastics, amusement parks, and trampoline parks).
While sophisticated wearable personal protection devices exist, the state of the art in fall arrest and protection currently consists of deploying inflatable, high-strength vinyl airbags located on the ground surface in the area around the potential fall zone. Typically using a combination of netting and air bladders to decelerate and absorb the kinetic energy of the falling object or person, the prevailing method of maintaining sufficient air pressure requires the use of a continuous stream of air from a pneumatic device such as compressors or turbine systems. Such inflatable systems are known to be efficacious in fall protection, are relatively inexpensive, and are conveniently portable. However, the need to use a continuously operating pneumatic device places significant energy, ventilation, and other operational demands on the operator while increasing setup and breakdown times. Additionally, such systems are exposed to the risk of power interruption leading to depressurization and the potential for exhaust fumes to reach dangerous levels due to loss of ventilation.
The weakest component of the otherwise efficacious fall protection systems is their reliance upon continuous flow air pressurization and the constituent requirements for supporting said. It stands to reason that a technology that can remove such requirements would have great instrumental value in the evolution of the state of the art in the fall protection sector. The following section will summarize the manner the invention being presented solves the air pressurization dilemma.

### SUMMARY

An object of the invention is to provide an inflatable fall protection system that absorbs the impact of a falling person or object in a manner that reduces the potential for damage, injury, or death. Another object of the invention is to remove the requirement of a continuous flow of air from pneumatic devices by creating a valve system that will only require one discrete inflation per use. Another object of the invention is to create a modular design that allows for multiple shape configurations while maintaining interconnectivity between inflation modules and consistent structural integrity across the whole of the customized system.

### BRIEF DESCRIPTION OF THE DRAWINGS

FIG. 1A outlines the size and placement of the fall bags as they could be used for an F-22 jet plane.

FIG. 1B is a rear view, horizontal depiction of the fall bags as they could be used for an F-22 jet plane.

FIG. 2A depicts rectangular bags with air valves and connections, which may be connecting buckles. The air valve may be used to fill the bag with air.

FIG. 2B depicts triangular bags which may incorporate air bags with air valves and connections, where the connections may be connecting buckles.

FIG. 3A depicts a view of two rectangular air bags joined to a triangular bag.

FIG. 3B depicts a separate view of two rectangular air bags joined to a triangular bag.

FIG. 4 is a depiction of a pressure relief valve body that retains a valve component, or pressure relief valve cap, as well as a spring and a bolt or screw that connects the valve component, or pressure relief valve, to the valve body.

FIG. 5 depicts a pressure relief valve cap.

FIG. 6 depicts a pressure relief valve cap that fits inside of the valve body (see FIGS. 4 and 5).

FIG. 7 depicts the pressure relief valve cap, which may be forced against the valve body by a spring, from the opposite side as in FIG. 6.

FIG. 8 depicts a valve body with a screw and a spring on the screw that holds the pressure relief valve against the valve body.

FIG. 9 depicts measurements of an embodiment of a pressure relief valve, where A is the valve body, B is the valve cap, C is the a metric o-ring, which may be 5.30 mm×90.00 mm fpm 75, D is the bolt, and E is the spring.

FIG. 10 is a depiction of the valve placed in the surface of the airbag, where the visible exterior facing out from the surface of the exposed airbag corresponds with the element B side of FIG. 9.

FIG. 11 is a depiction of a fall protection system in application with an F-22 Jet plane.

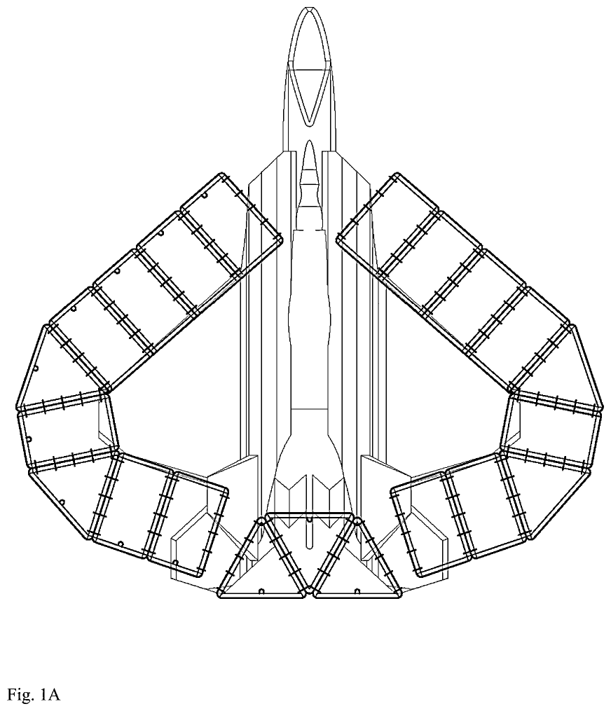

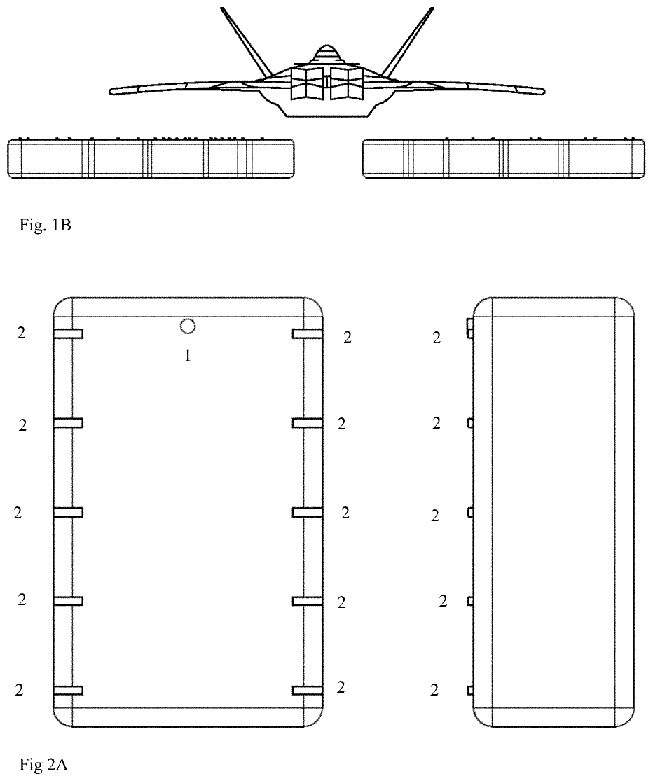

### DETAILED DESCRIPTION

Industries that require workers to operate with uninhibited mobility from great heights are in need of a fall-impact protection system that can break a fall of an object or person while reducing the potential for damage, injury, or death.

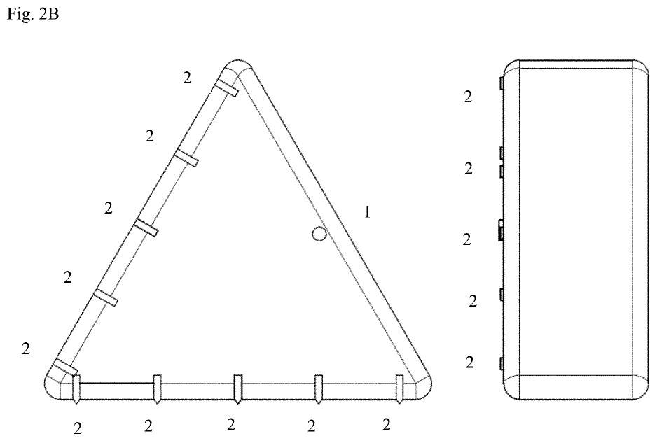

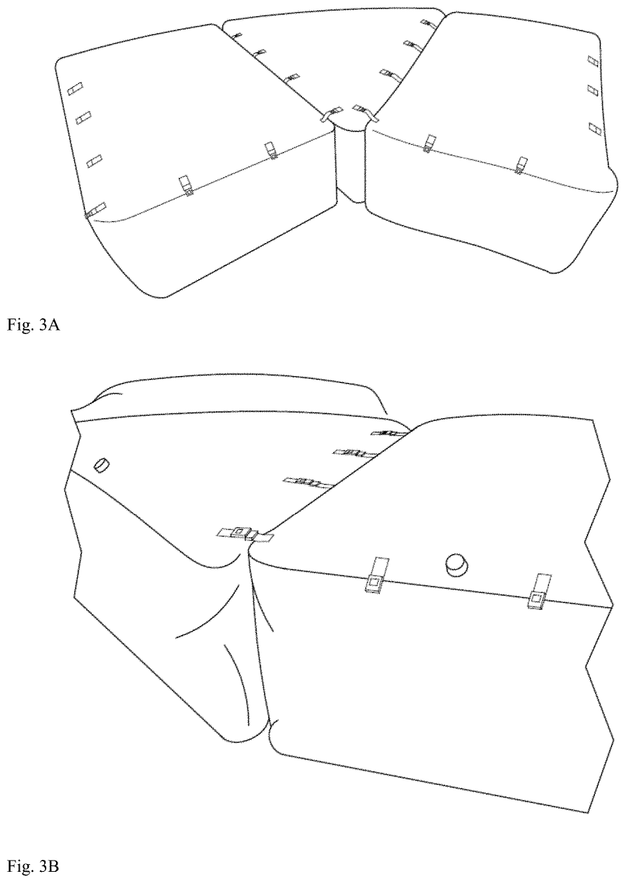

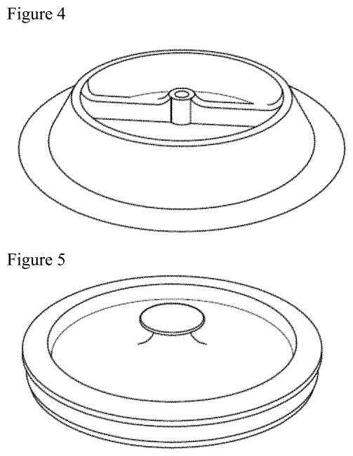

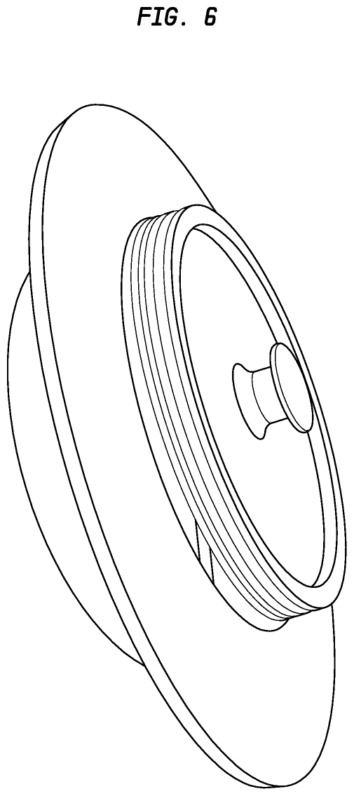

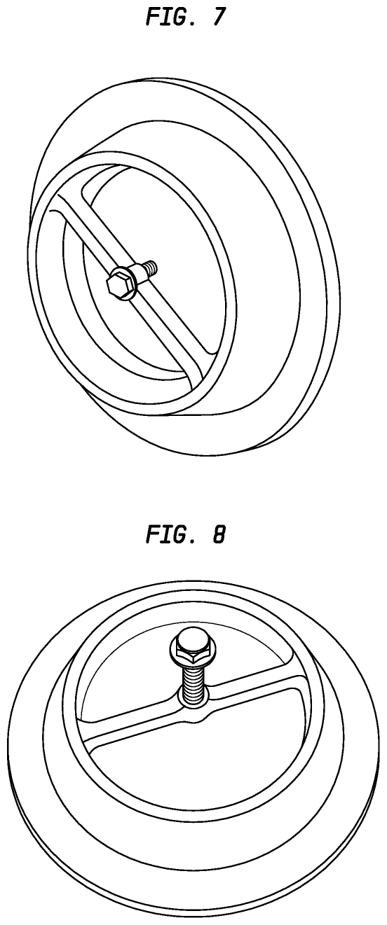

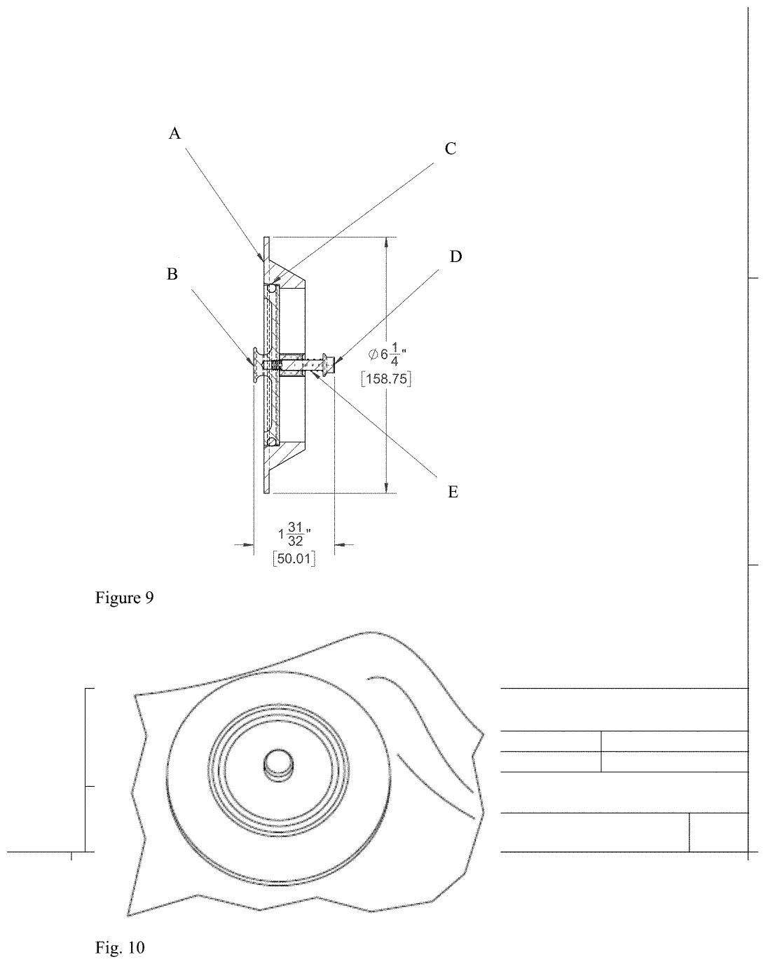

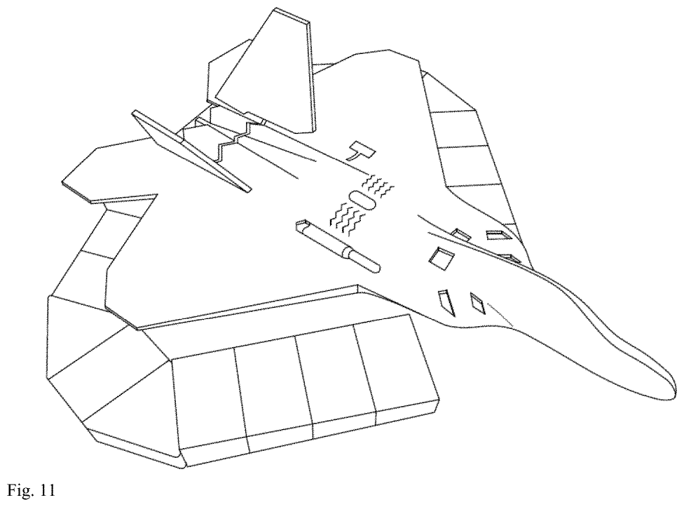

Disclosed is an invention to provide that protection with an airtight modular system. The system comprises multiple inflatable bags, connection straps, and an optional pressure relief valve. Inflatable bags may come in different shapes. Embodiments may combine triangular bags of, for example, 8′ length×5′ width×3′ height, with multiple connecting buckles and an at least one air valve 1. A triangular bag may be a modular component of dimensions 9′ length for each side of the triangle, and 3′ height (or, depth). See FIGS. 2A and 2B, with air valves 1 and buckles 2. A purpose of the instant invention is to create a cost-effective, modular, quick to set-up, no limited target area/sweet spot safety system. A rescue system involving a lanyard designed for fall protection, at certain heights, imposes forces on the anchor that the anchor is not designed for. Embodiments of the instant invention may provide risk reduction for fall hazards of up to 70 feet or higher, depending on an aircraft or structure size, for example. Further, embodiments of this invention allow a fall from height not only of different structure, but for a building, launch aircraft, or other structure that happens to have unique properties that would not allowing for the use of lanyards.

Embodiments of the invention may also omit any need of a 110 v inflation blower or gasoline powered blowers, which create unnecessary risks to workers. Further, by being air-inflated, embodiments of the invention may allow for more compact, smaller storage space when the system is not being used.

In embodiments of the invention, fall bags filled with air may be placed around a structure and connected, for example with buckles. Air bags may also incorporate air pressure valves, where the air valves do not require continuous air flow to pressurize the air bag(s). Most embodiments of the instant invention will include at least one pressure relief valve comprised of a valve component, or pressure relief valve cap component, as well as a spring and a bolt that connects the valve component (or, pressure relief valve component), and valve and spring to the valve body. The valve component may be held inside the air bag by spring forces and, on kinetic pressure received by the air bag, a force will push the air against the valve, forcing the valve to extend out, to the exterior of the bag, breaking the seal, releasing air pressure and decelerating any kinetic force, for example from a worker's fall.

An embodiment of this invention may be comprised of:
A 4″ pressure relief valve opening
3′ high bags, where the length varies with height of fall but the height of bag should stay the same in many embodiments
1.5″ seat belts used for the buckles

Embodiments of the invention are airtight (the airbags) and, after inflation, a blower system is not required. Embodiments are constructed through a heat welding process to produce a solidly constructed, airtight system, made to release air pressure upon impact at the valves and at no other location. The trigger for the air relief valve itself would be the body's impact on the bag. A specific, one-size-fits-all PSI is not required for use of the system. Inflation levels on the bags, in use are relatively low, which allows for the pressure to be created and released upon impact. The number of valves used would vary based on the rating/height of the fall requirements. For an F22 at standard heights above ground, for example, embodiments would use 2 valves per bag. Embodiments of the invention do not require a continuously operating pneumatic device, which would place significant energy, ventilation, and other operational demands on an operator while increasing setup and breakdown times. Additionally, embodiments do not expose workers to risks of power interruption leading to depressurization and the potential for exhaust fumes to reach dangerous levels due to loss of ventilation.

The invention relates to fall-impact protection systems for industries that require workers to operate with uninhibited mobility from great heights.

The present invention is related to a modular and interconnectable welded vinyl airbag system for creating a fall-protection zone. It has a cap and valve system that permits air inflation while precluding depressurization. The system will also provide the option for inserting pressure relief valves that permit the system to depressurize the particular airbag module receiving impact at a rate that safely decelerates the person or object.

1. A fall impact protection system for preventing or reducing injury or damage, the system comprising:
deploying inflatable airbags located on the ground surface in the area around the potential fall zone, where the airbags are buckled together to create a fall-protection zone, and where an at least one airbag contains a trigger mechanism for releasing air pressure due to a fall.

2. The system of claim 1, where at least one of the airbags contains two air valves, and where the trigger mechanism is comprised of an impact on an airbag, and where the trigger mechanism causes a pressure relief valve to release air.

3. The system of claim 1, where the airbags are sealed and no continuous air source operates to continue to fill the air bags.

4. The system of claim 1, where the airbags are vinyl.

5. The system of claim 1, where the trigger mechanism is comprised of a valve cap, a valve body, a bolt, a spring, and an o-ring.

6. The system of claim 5, where a continuous blower system is not required to pressurize the airbags after an initial inflation.

7. A fall impact protection system comprised of bladders, valves, and connectors between valves, where the valves are comprised of a fastener, a resilience device for storing elastic potential energy, and a valve plate that extrudes on a predetermined amount of kinetic force to decelerate an impact.

8. The system of claim 7 where the bladder comprises a low-elasticity flexible material that expands to a substantially fixed volume, and where the bladder receives a predetermined volume of pressurized gas.

9. The system of claim 7 that has a power source removed after pressurization.

10. The system of claim 7 where the system is capable of sensing accelerations exceeding a predetermined threshold.

11. The system of claim 7, where a plurality of bladders contain at least two pressure relief valves.

12. The system of claim 7, where the system is used as a secondary fall protection system.

13. The system of claim 7, where an at least one valve is located towards a corner of a bladder.
